(19) United States
(12) Patent Application Publication
(10) Pub. No.: US 2008/0121505 A1
(43) Pub. Date: May 29, 2008

(54) Switch apparatus

(75) Inventors: Isao Maeda, Aichi (JP); Hiroshi Kusama, Aichi (JP); Hideki Matsumura, Aichi (JP); Norikazu Yoshida, Aichi (JP); Fumitaka Hayase, Aichi (JP)

Correspondence Address: MORGAN LEWIS & BOCKIUS LLP, 1111 PENNSYLVANIA AVENUE NW, WASHINGTON, DC, 20004, US

(73) Assignee: Kabushiki Kaisha Tokai Rika Denki Seisakusho

(21) Appl. No.: 11/984,497

(22) Filed: Nov. 19, 2007

(30) Foreign Application Priority Data
Nov. 24, 2006 (JP) 2006-317108

(51) Int. Cl. H01H 1/00

(52) U.S. Cl. 200/283

(57) ABSTRACT

In an arrangement of carrying out a switch operation of operating a driven mechanism by an operating member operated by a user and bringing and detaching contacts provided to movable contact pieces into contact with and from fixed contacts by deforming and recovering the movable contact by the operated driven mechanism, the contacts of the movable contact pieces are formed by carrying out mechanical working of projecting portions of the movable contact pieces.

### BACKGROUND OF THE INVENTION

The present invention relates to a switch apparatus improving a contact of a movable contact piece.

In a background art, there is provided a switch apparatus for a vehicle of, for example, an automobile or the like in which a cam plate is moved by an operating member of a lever, a knob or the like manipulated by a user, a push rod provided to the movable contact piece is pressed by the moved cam plate to deform the movable contact piece, or the movable contact piece is recovered by releasing a press pressure thereof to thereby carry out switch operation of bringing and detaching a contact (movable contact) provided to the movable contact piece into contact with and from an opposed fixed contact (refer to, for example, JP-TM-A-7-5879)

FIG. 7 and FIG. 8 show a structure of movable contact pieces 1-3 of the background art in the above-described switch apparatus. The movable contact pieces 1-3 of the background art respectively include attaching holes 4-6 at one end portions thereof, include push rods 7-9 at middle portions thereof, and include contacts (movable contacts) 10-12 at other end portions thereof. The contacts 10-12 of the movable contact pieces 1-3 are constituted by inserting to fit to calk contact rivets 16-18 of other members respectively comprising a noble metal excellent in a conductivity of silver or the like to holes 13-15 formed at the respective other end portions of the movable contact pieces 1-3.

Therefore, the contact rivets 16-18 which are other members and expensive are needed for respective ones of the movable contact pieces 1-3, and there is needed an operation of successively inserting to fit to calk the respective ones of the contact rivets 16-18 to the holes 13-15 of the movable contact pieces 1-3 to increase cost.

### SUMMARY OF THE INVENTION

The invention has been carried out in view of the above-described situation, and therefore, it is an object thereof to provide a switch apparatus capable of constituting a contact of a movable contact piece without needing an expensive other member and also without needing operation of integrating the other member to be able to reduce cost.

In order to achieve the above-described object, a switch apparatus of the invention is characterized in comprising an operating member manipulated by a user, a driven mechanism operated by the operating member, a movable contact piece deformed and recovered by the driven mechanism, and a fixed contact opposed to a contact provided to the movable contact piece and brought into contact with and detached from the movable contact piece, wherein the contact of the movable contact piece is formed by carrying out mechanical working of projecting a portion of the movable contact piece.

According to the above-described means, the contact of the movable contact piece is formed by carrying out the mechanical working of projecting the portion of the movable contact piece, and therefore, the contact of the movable contact piece can be constituted without needing an expensive other member and without needing also an operation of integrating the other member to be able to reduce cost.

### BRIEF DESCRIPTION OF THE DRAWINGS

FIG. 1 is a perspective view of a movable contact piece showing an embodiment of the invention.

FIG. 2 is a vertical sectional side view of a movable contact piece.

FIG. 3 is a front view of a switch apparatus.

FIG. 4 is a sectional view taken along a line X-X of FIG. 3.

FIG. 5 is a sectional view taken along a line Y-Y of FIG. 3.

FIG. 6 is an outer bottom face view of a switch apparatus body.

FIG. 7 is a view in correspondence with FIG. 1 showing a background art.

FIG. 8 is a view in correspondence with FIG. 2.

### DETAILED DESCRIPTION OF PREFERRED EMBODIMENTS

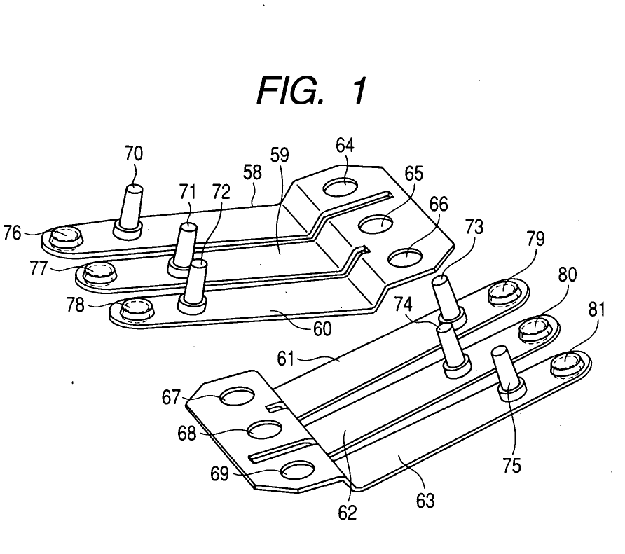

In the following, the invention is applied to a switch apparatus for a vehicle of for an automobile or the like and an explanation will be given of an embodiment thereof (one embodiment) in reference to FIG. 1 through FIG. 6.

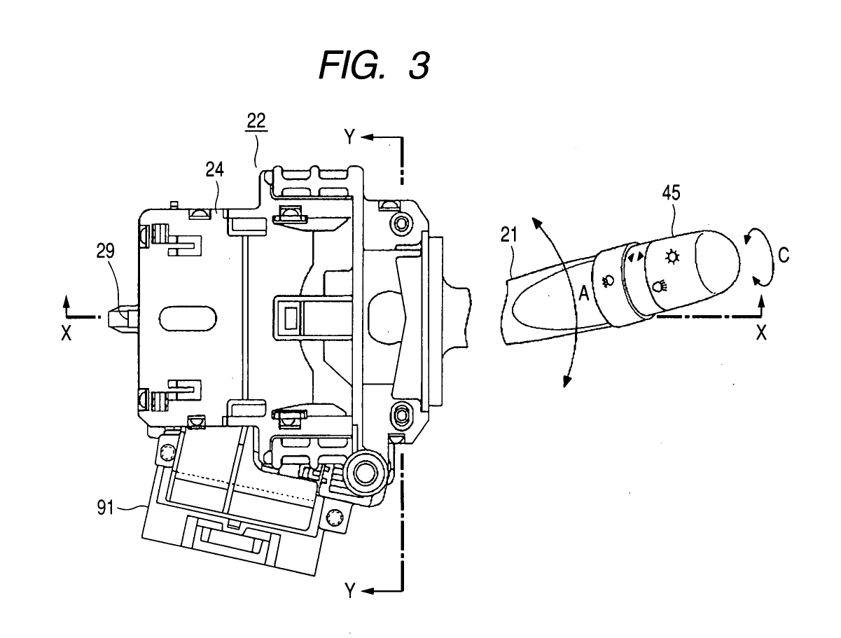

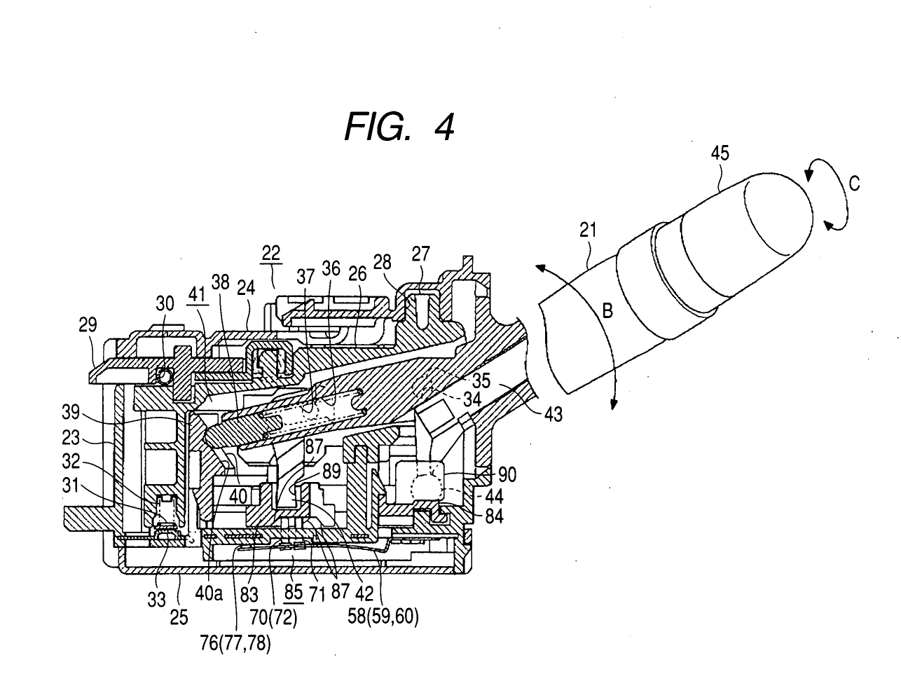

First, FIG. 3 and FIG. 4 show a switch apparatus for a vehicle of for an automobile or the like by omitting a middle portion of a lever 21 constituting an operating member, and the switch apparatus is constituted by constituting a main body by a body 23 (refer to FIG. 4), mounting an upper cover 24 frontward therefrom (upward therefrom in FIG. 4) and mounting an under cover 25 rearward therefrom (downward therefrom in FIG. 4).

A bracket 26 constituting a lever supporting member is inwardly provided between the body 23 and the upper cover 24. According to the bracket 26, a front face portion, a left side face portion on a side opposed to a side of the lever 21, and face portions other than upper and lower (directions orthogonal to paper face of FIG. 4) two side face portions (right side face portion and rear face portion) are opened, a shaft portion 27 is projected at the right side portion of the front face portion thereamong, the shaft portion 27 is fitted to a recess portion 28 formed at the upper cover 24 to thereby support the bracket 26 pivotably in a direction orthogonal to paper face of FIG. 4 centering on the shaft portion 27 (direction indicated by an arrow mark A in FIG. 3).

On the other hand, a ratchet 29 is urged to a side of a cancel cam by a spring 30 to be mounted to a left side portion of the front face portion of the bracket 26. Further, the cancel cam is present on a left side of FIG. 4 of the ratchet 29 although not illustrated and is integrally rotated with a steering wheel (which is not also illustrated). Further, a movable contact piece 31 for a turn signal is urged to a rear side by a spring 32 to be mounted to a rear side (lower side of FIG. 4) of a left side face portion of the bracket 26, and a fixed contact 33 for the turn signal is mounted to an inner bottom face portion of the body 23 to be opposed thereto.

Further, holes 34 (only an upper side one is illustrated in FIG. 4) are formed at two upper and lower side face portions of the bracket 26, a shaft portion 35 is projected at a base portion of the lever 21 inserted to an inner portion of the bracket 26 to be opposed thereto, and by fitting the shaft portion 35 to the hole 34 of the bracket 26, the lever 21 is pivotably supported in a direction indicated by an arrow mark B in FIG. 4 (direction orthogonal to paper face of FIG. 3) centering on the shaft portion 35.

The base portion of the lever 21 is also formed with a deep hole 36 at a portion thereof on a left side of the shaft portion 35, and a spring 37 and a node piece 38 are contained in the hole 36. Further, a detent plate 39 is integrated to the body 23 to be opposed thereto. The detent plate 39 includes a plurality of node valleys 40 having inclined faces 40a in a front and rear direction to align to be arranged on a circular arc centering on the shaft portion 27 of the bracket 26, and a node mechanism 41 for the lever 21 is constituted by the node piece 38 and the spring 37 and the node valley 40.

Further, the base portion of the lever 21 is attached with an arm member 42 movably in a left and right direction of FIG. 4. A side of a front end portion (right side) of the base portion of the lever 21 is hollow and a shaft 43 is rotatably inserted to an inner portion thereof. A base end portion of the shaft 43 is projected with a driven portion 44, on the other hand, a front end portion of the shaft 43 is attached with a knob 45 constituting an operating member to be disposed at a front end portion of the lever 21 to be provided rotatably in a direction indicated by an arrow mark C along with the shaft 43.

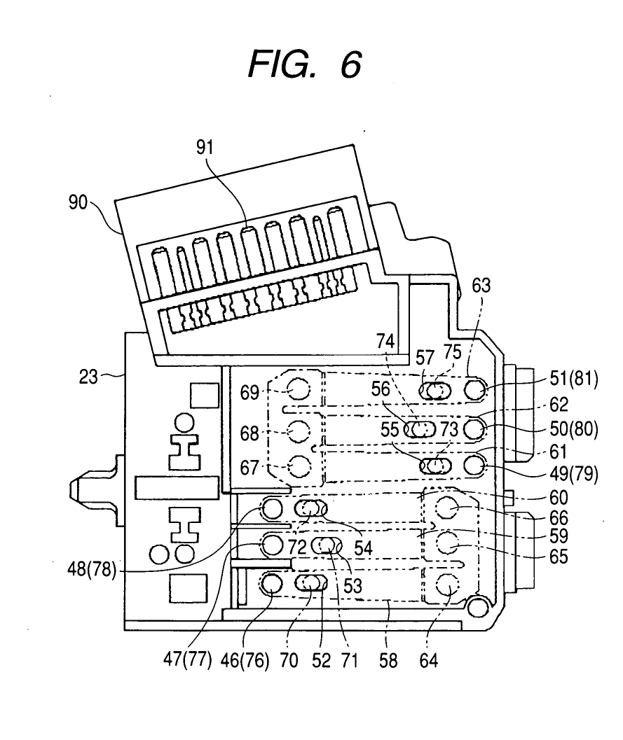

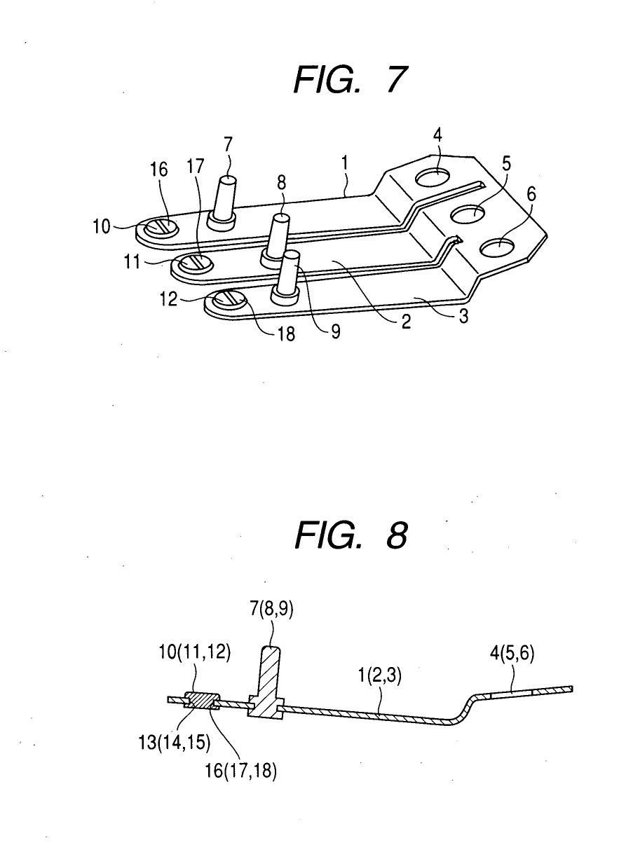

Here, FIG. 6 shows an outer bottom face portion of the body 23, as is apparent from FIG. 6, the outer bottom face portion of the body 23 is respectively mounted with fixed contacts 46-48 for passing signal and dimmer control on a left side and fixed contacts 49-51 for light control on a right side, further, portions of the body 23 proximate to the fixed contacts 46-48, 49-51 are respectively formed with holes 52-54, 55-57.

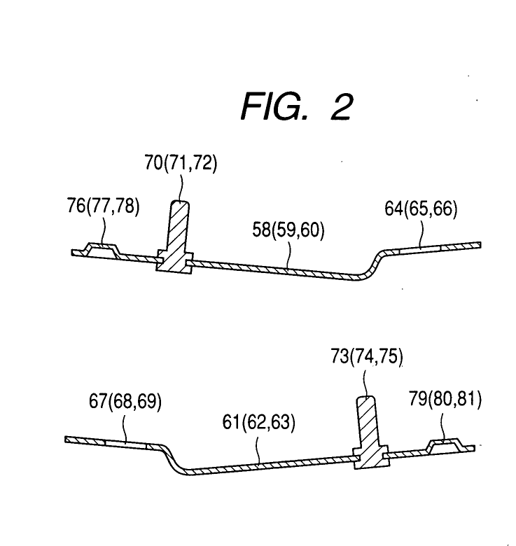

In contrast thereto, numerals 58-60 designate movable contact pieces for passing signal and dimmer control, numerals 61-63 designate movable contact pieces for light control shown in FIG. 1 and FIG. 2, these are conductive members, formed by a tongue-like shape particularly by metal plates, copper plates thereamong, integrally formed respectively at one end portions (right side end portions for the movable contact pieces 58-60, left side end portions for the movable contact pieces 61-63), and include attaching holes 64-66, 67-69 at the one end portions.

Further, middle portions of the movable contact pieces 58-60, 61-63 proximate to other end portions thereof are inserted with push rods 70-72, 73-75, and the other end portions include contacts (movable contacts) 76-78, 79-01. The contacts 76-78, 79-81 for the movable contact pieces 58-60, 61-63 are formed by mechanically working to project the other end portions constituting also the respective portions of the movable contact pieces 58-60, 61-63, particularly by pressing by a shape of a bottomed short cylinder, a shape of a short cylinder thereamong in this case.

Further, in this case, the contacts 76-78, 79-81 formed by the mechanical working of the movable contact pieces 58-60, 61-63 are made to constitute transition destination sides of ‘transition phenomenon’ brought about as described later between the contacts 76-78, 79-81 and the fixed contacts 46-48, 49-51. In addition thereto, the contacts 76-78, 79-81 of the movable contact pieces 58-60, 61-63 are subjected to a treatment for promoting conductivity, specifically, subjected to plating of a noble metal only at surfaces thereof.

Further, the movable contact pieces 58-60, 61-63 are attached to the outer bottom face portion of the body 23 by screws (not illustrated), respectively inserted to attaching holes 64-66, 67-69, and in the attaching state, the push rods 70-72 of the movable contact pieces 58-60 penetrate the holes 52-54 of the body 23 into the body 23, and the push rods 73-75 of the movable contact pieces 61-63 similarly penetrate the holes 55-57 into the body 23. Further, the contacts 76-78 of the movable contact pieces 58-60 are opposed to the fixed contacts 46-48, and the contacts 79-81 of movable contact pieces 61-63 are opposed to the fixed contacts 49-51.

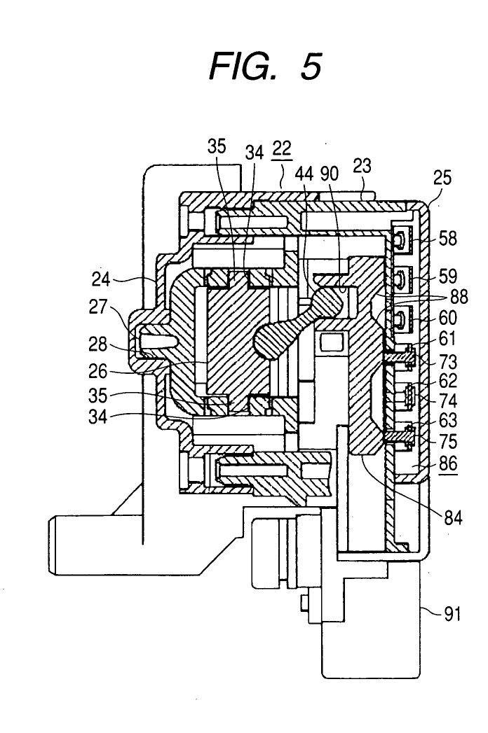

Further, on an inner bottom face of the body 23, a cam plate 83 for passing signal and dimmer control is arranged movably in a left and right direction of FIG. 4 to be disposed upward from the push rods 70-72 of the movable contact pieces 58-60, and a cam plate 84 for light control is arranged movably in a direction orthogonal to paper face of FIG. 4 (up and down direction of FIG. 5) to be disposed upward from the push rods 73-75 of the movable contact pieces 61-63.

The cam plates 83, 84 constitute driven mechanisms 85, 86 along with the push rods 70-72, 73-75 of the movable contact pieces 58-60, and include cam portions 87, 88 respectively in shapes of inclined faces by shapes which differ for respective push rods 70-72 (respective movable contact pieces 58-60) as well as respective push rods 73-75 (respective movable contact pieces 61-63), although not illustrated in details.

Further, the cam plates 83, 84 respectively include bifurcated receiving portions 89, 90 on sides opposed to sides of the push rods 70-72, 73-75, and the receiving portion 89 of the cam plate 83 thereamong is opposed thereto in a left and right direction of FIG. 4, and a front end portion of the arm member 42 attached to the base portion of the lever 21 is disposed therebetween.

On the other hand, the receiving portion 90 of the cam plate 84 is opposed thereto in a direction orthogonal to paper face of FIG. 4 (up and down direction of FIG. 4) and a front end portion of the driven portion 44 projected at the base end portion of the shaft 43 is disposed therebetween.

Further, numeral 91 shown in FIG. 3, FIG. 5 and FIG. 6 designates a terminal portion integrally formed with the body 23 and including contact terminals 92 of a number communicated with the fixed contact piece 33 and the fixed contacts 46-51.

Now, when a user manipulates the lever 21 in a direction indicated by the arrow mark A in FIG. 3, the bracket 26 is pivoted in the same direction centering on the shaft 27 by applying a load in the direction to the bracket 26.

When the bracket 26 is pivoted as described above, at the node mechanism 41, the node piece 38 is engaged with a contiguous one of the node valley 40 to provide a node in pivoting the bracket 26 and the lever 21. Further, along therewith, on a rear side of the left side face portion of the bracket 26, the movable contact piece 31 carries out a switch operation of being brought into contact with and detached from the fixed contact piece 33. The switch operation at this occasion is provided to lighting the turn signal of the vehicle.

Further, although the bracket 26 and the lever 21 pivoted to be provided with a node stay at the position, when the steering wheel is operated to rotate in a direction opposed to the pivoting direction, by the cancel cam integrally rotated with the steering wheel, in accordance with kicking to pivot the ratchet 29, the bracket 26 and the lever 21 are returned.

On the other hand, when the lever 21 is operated in a direction indicated by the arrow mark B in FIG. 4, the lever 21 is pivoted in the same direction centering on the shaft portion 35. Further, along therewith, the lever 21 moves the cam plate 83 in the left and right direction of FIG. 4 by the base portion from the arm member 42 by way of the receiving portion 89 of the cam plate 83. In accordance therewith, the movable contact pieces 58-60 are deformed by respectively pressing the push rods 70-72 by the cam portions 87 present for the respective push rods 70-72 of the cam plate 83, or recovered by releasing the press pressure.

Therefore, at this occasion, the cam plate 83 and the push rods 70-72 function as the driven mechanism 85 for deforming and recovering the movable contact pieces 58-60 by the lever 21 manipulated by the user, as a result, the contacts 76-78 of the movable contact pieces 58-60 carry out a switch operation of being brought into contact with and detached from the opposed fixed contacts 46-48. The switch operation at this occasion is provided to carry out passing signal and dimmer control of the vehicle. Further, the pivoting of the lever 21 at this occasion is provided with the node by sliding and engaging the node valley 40 of the node mechanism 41 with the node piece 38 in the inclined direction.

Further, when the knob 45 is operated to rotate in the direction indicated by the arrow mark C in FIG. 3 and FIG. 4, in accordance with rotating the shaft 43 in the same direction, the cam plate 84 is moved in the up and down direction of FIG. 5 by way of the receiving portion 90 of the cam plate 84 by the driven portion 44. In accordance therewith, the movable contact pieces 61-63 are deformed by respectively pressing the push rods 73-75 by the cam portions 88 present for the respective push rods 73-75 of the cam plate 84, or recovered by releasing the press pressure.

Therefore, at this occasion, the cam plate 84 and the push rods 70-72 function as the driven mechanism 86 of deforming and recovering the movable contact pieces 61-63 by being operated by the knob 45 manipulated by the user, as a result, the contacts 79-81 of the movable contact pieces 61-63 carry out the switch operation of being brought into contact with and detached from the opposed fixed contacts 49-51. The switch operation at this occasion is provided to carry out light control of the vehicle. Further, pivoting of the knob 45 at this occasion is provided with the node by the node mechanism, not illustrated, provided between the knob 45 and the lever 21.

Further, according to the above-described arrangement, the contacts 76-81 of the movable contact pieces 58-63 are formed by carrying out mechanical working of projecting portions of the movable contact pieces 58-63, and therefore, the contacts 76-81 of the movable contact pieces 58-63 can be constituted without needing an expensive other member as in the contact rivet comprising a highly conductive noble metal of the background art, and without needing also operation of integrating the other member to be able to reduce cost.

In addition thereto, in the above-described arrangement, the contacts 76-78, 79-81 of the movable contact pieces 58-60, 61-63 are made to constitute transition destination sides of transition phenomenon brought about between the contacts 76-78, 79-81 and the fixed contacts 46-48, 49-51.

The ‘transition phenomenon’ between the contacts mentioned here indicate a phenomenon in which a portion of a surface of the contact is transited to an opposed contact when opening and closing the contacts, which is generally brought about when opening and closing a direct current, however, there is a case in which the phenomenon is observed also when opening and closing an alternating current. A direction of the transition is determined by a voltage, a current, a material of the contact, in the case of the direct current, these are constant, and therefore, a projection is produced at one contact and a recess is produced at other contact opposed thereto (even in an alternating current, in a case that a phase of opening and closing is constant, the phenomenon is brought about). The transition is liable to be brought about by a load having an inputted current larger than a shut off current, for example, opening and closing a lamp, a capacitor load (a switching power source, a load connected by a long cable or the like).

In the above-described arrangement, by constituting the transition destination sides of ‘transition phenomenon’ brought about respectively between the contacts 76-78, 79-81 and the fixed contacts 46-48, 49-51 by the contacts 76-78, 79-81 of the movable contact pieces 58-60, 61-63, transition is brought about from the fixed contacts 46-48, 49-51 to the contacts 76-78, 79-81 of the movable contact pieces 58-60, 61-63, as a result, projections are produced at the contacts 76-78, 79-81 of the movable contact pieces 58-60, 61-63, and recesses are produced at the fixed contacts 46-48, 49-51.

Therefore, reductions are not brought about at the contacts 76-78, 79-81 of the movable contact pieces 58-60, 61-63, and therefore, even when the contacts are subjected to a treatment of promoting a conductivity, it is not necessary to carry out the treatment heavily and thickly, the treatment may be carried out only at surfaces thereof, for example, plating of a noble metal may be carried out only at the surfaces, as described above, thereby, a reduction in cost can be achieved while promoting the conductivity.

Further, the invention is not limited only to the embodiment mentioned above and as shown by the drawings, particularly, the invention is not limited to use for a vehicle as an object of applying the switch apparatus and is widely applicable generally to switch apparatus. Further, also the operating member of the switch apparatus is not limited to the pivoting lever or the rotating knob but may be a slide knob or the like. Further, the movable contact piece is not limited to a movable contact piece of detaching the contact from the fixed contact when the movable contact piece is deformed by pressing the push rod portion by the cam plate, conversely, may be a movable contact piece for bringing the contact into contact with the fixed contact. Otherwise, the invention can be embodied by being pertinently changed within the range not deviated from the gist.

What is claimed is:

1. A switch apparatus comprising:
an operating member to be manipulated by a user;
a driven mechanism operated by the operating member;
a movable contact piece that is deformed and recovered by the driven mechanism and includes a contact; and
a fixed contact opposed to the contact of the movable contact piece and brought into contact with and detached from the movable contact piece;
wherein the contact of the movable contact piece is formed by carrying out mechanical working of projecting a portion of the movable contact piece.

2. The switch apparatus according to claim 1, wherein the contact of the movable contact piece is made to constitute a transition destination side of a transition phenomenon brought about between the contact and the fixed contact.
